(19) United States
(12) Patent Application Publication
(10) Pub. No.: US 2025/0182195 A1
(43) Pub. Date: Jun. 5, 2025

(54) INTEGRATED SERVICES EXPERIENCE

(71) Applicant: American Express Travel Related Services Company, Inc., New York, NY (US)

(72) Inventors: Joshua Archer, Atlanta, GA (US); Brad Johnsman, Phoenix, AZ (US); Himanshu Sharma, Jersey City, NJ (US)

(21) Appl. No.: 18/525,126

(22) Filed: Nov. 30, 2023

(51) Int. Cl. G06Q 40/02; H04L 67/02

(52) U.S. Cl. CPC G06Q 40/02; H04L 67/02

(57) ABSTRACT

Disclosed are various embodiments for an integrated services experience. Various embodiments of the disclosure can receive a first request from a client device to prepare a disbursement to a target account. Various embodiments can then identify target account preferences that correspond to the target account. The target account preferences can include various disbursement methods accepted by the target account. Then, various embodiments can send a list of the disbursement methods accepted by the target account to the client device, which the client can choose a disbursement method and a disbursement amount. Various embodiments can then initiate a disbursement to the target account to receive the disbursement amount using the chosen disbursement method.

### BACKGROUND

Financial software for businesses are often siloed over various services or software platforms. Business administrators are often required to use various services or software platforms to perform various tasks, which can reduce efficiency and be financially burdensome. For instance, bank systems are primarily performing Automated Clearing House (ACH) or wire transfers, whereas card payments are performed by processors. Additionally, because financial services or software platforms do not often integrate with each other, the business administrator must often duplicate data entries for each service or software platform that uses such data. The duplicate entry of data can result in various errors that may initially go unnoticed. For a business using various financial software, entering data incorrectly could result in failing to pay a vendor/merchant by the expected payment date, which could result in various business and legal consequences.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a network environment according to various embodiments of the present disclosure.

FIG. 2 is a flowchart illustrating one example of functionality implemented as portions of an application executed in a computing environment in the network environment of FIG. 1 according to various embodiments of the present disclosure.

FIGS. 3A and 3B are flowcharts illustrating one example of functionality implemented as portions of an application executed in a computing environment in the network environment of FIG. 1 according to various embodiments of the present disclosure.

### DETAILED DESCRIPTION

Disclosed are various approaches for managing an integrated services experience. Current money movements today are often siloed and available at different financial platforms. For instance, bank systems are primarily performing Automated Clearing House (ACH) or wire transfers, whereas card payments are performed by processors. Accordingly, businesses often require various financial platforms to complete very basic tasks.

A single financial platform that combines these siloed products can provide unique benefits to its customers that cannot be realized by the siloed treatment of competitor financial software alone. Accordingly, various embodiments of the present disclosure can represent a singular platform that allows merchants and customers to move money in a dynamic way with less user provided information. Various embodiments of the present disclosure can orchestrate the movement of resources between different sources, destinations, and mediums for a buyer or supplier to both choose how they want to be paid (e.g., via card, ACH, wire, international ACH, checks, line of credit, etc.) and where they want to pay from (e.g., via card, ACH, wire, international ACH, checks, line of credit, etc.). Further, various embodiments of the present disclosure can provide a list of people to pay that is based on a merchant network and allows those merchants to customize options for how they are paid.

For example, a large financial institution may have an expansive merchant list that includes various information about how that merchant prefers to be paid by their vendors or how they wish to pay their vendors. However, starting to work with new vendors can be difficult because sharing the necessary financial account information to accept payments can be cumbersome and error prone. A large financial organization can leverage its expansive merchant list to make working with new partner merchants or vendors easier by allowing all merchants to easily direct payments to fellow merchants within that financial organization's expansive merchant list. Various embodiments of the present disclosure can use the merchant list to allow other merchants or vendors to find and select a merchant that they wish to pay. Because merchants can include their preferences on how they wish to be paid, other merchants or vendors can also find and select the payment methods for such a merchant. Such embodiments of the present disclosure can reduce the amount of data entry for a business and speed up the process of on-boarding new vendors/merchants.

Further, various embodiments of the present disclosure can assist merchants make payments in various forms of currency or make payments over various payment rails. As previously discussed, a merchant can have a preferred payment method. That payment method may only accept funds over a specific payment rail (e.g., via card, ACH, wire, international ACH, checks, line of credit, etc.) or in a specific type of currency (e.g., United States Dollar, British Pound, Bitcoin, etc.). However, not all merchants will have accounts to pay the merchant over their preferred payment rail or with a specific type of currency. Accordingly, various embodiments of the present disclosure can be used as a “middleman” for the transaction by converting it on the payor's behalf, saving time and effort with a “2-legged transaction” that goes directly to where the money would eventually end up.

Various other features are discussed throughout this disclosure. For instance, a merchant may wish to borrow funds (e.g., a loan, an advance, etc.) from a financial institution as the funding source to make payments to another merchant. Various embodiments of the present disclosure can effectuate a loan whose funds can immediately be used to satisfy a payment to another merchant. In another example, a merchant can split payments between multiple payment sources to effectuate a full payment.

By combining these features, businesses can quickly and easily pay each other using various money movement means from a single platform, thus creating a global digital payment network that does not require repeatedly sharing personal and financial data. By securing personal and financial data from repeated sharing, businesses can better secure that information from persons trying to wrongfully access the information or financial accounts. In various embodiments of the present disclosure, a payor would merely need to identify the business they would like to transact with, but no further identifying information or financial account information would necessarily need to be shared. This bypasses the necessity of various trust mechanisms (e.g., general trust in business relationships, cryptographic trust in identity of credential holders, etc.) or legal barriers (e.g., various contracts, non-disclosure agreements, etc.) to sharing confidential personal or financial information.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

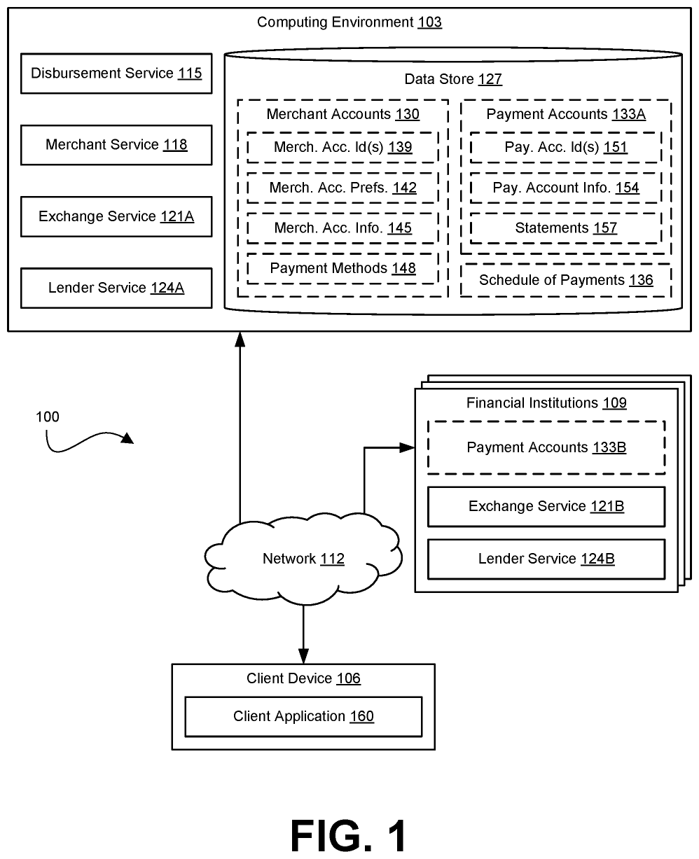

With reference to FIG. 1, shown is a network environment 100 according to various embodiments. The network environment 100 can include a computing environment 103, a client device 106, and financial institutions 109, which can be in data communication with each other via a network 112.

The network 112 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 112 can also include a combination of two or more networks 112. Examples of networks 112 can include the Internet, intranets, extranets, virtual private networks (VPNs), and similar networks.

The computing environment 103 can include one or more computing devices that include a processor, a memory, and/or a network interface. For example, the computing devices can be configured to perform computations on behalf of other computing devices or applications. As another example, such computing devices can host and/or provide content to other computing devices in response to requests for content. Moreover, the computing environment 103 can employ a plurality of computing devices that can be arranged in one or more server banks or computer banks or other arrangements. Such computing devices can be located in a single installation or can be distributed among many different geographical locations. For example, the computing environment 103 can include a plurality of computing devices that together can include a hosted computing resource, a grid computing resource, or any other distributed computing arrangement. In some cases, the computing environment 103 can correspond to an elastic computing resource where the allotted capacity of processing, network, storage, or other computing-related resources can vary over time.

Various applications or other functionality can be executed in the computing environment 103. The components executed on the computing environment 103 include disbursement service 115, merchant service 118, exchange service 121A (generically as “exchange service 121”), lender service 124A (generically as “lender service 124”), and other applications, services, processes, systems, engines, or functionality not discussed in detail herein.

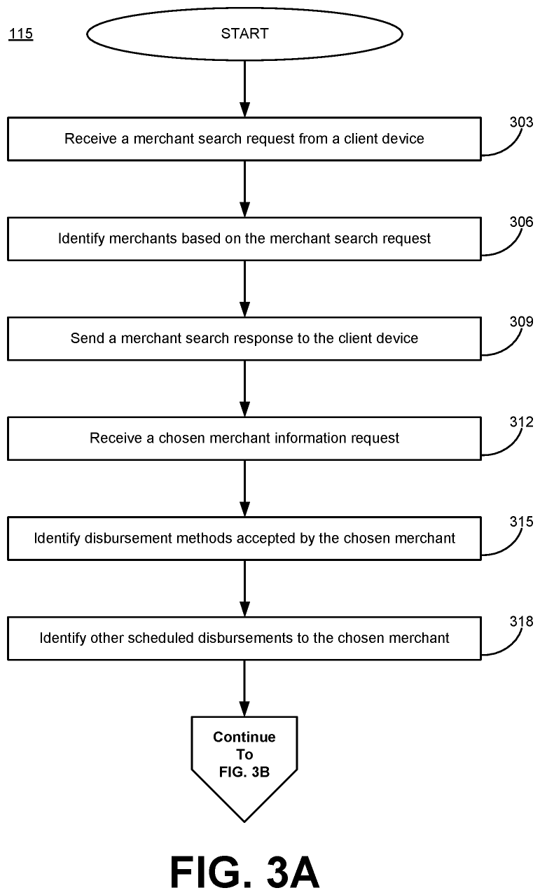

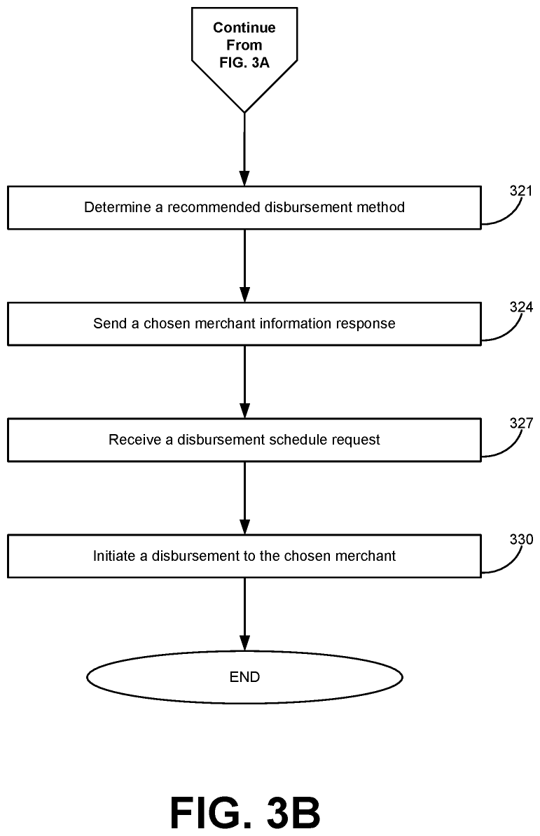

The disbursement service 115 can be executed to perform various functions. For instance, the disbursement service 115 can be executed to communicate with a client device 106 to schedule a disbursement or a payment to a merchant account 130 or to a payment account 133A (generically “payment account 133”). In some embodiments, the disbursement service 115 can receive a merchant search request from a client device 106. The disbursement service 115 can then identify one or more merchant accounts 130 based on the merchant search request, then the disbursement service 115 can send a merchant search response to the client device 106. Some embodiments can then receive a chosen merchant information request. The disbursement service 115 can next identify one or more disbursement methods accepted by the chosen merchant account 130. The disbursement service 115 can identify scheduled disbursements made by other clients to the chosen merchant account 130. The disbursement service 115 can further determine a recommended disbursement method. The disbursement service 115 can then send a chosen merchant information response. Some embodiments can then receive a disbursement schedule request and the disbursement service 115 can initiate a disbursement to the chosen merchant. Further details on the performance of these functions are further described in the discussion of FIGS. 3A and 3B.

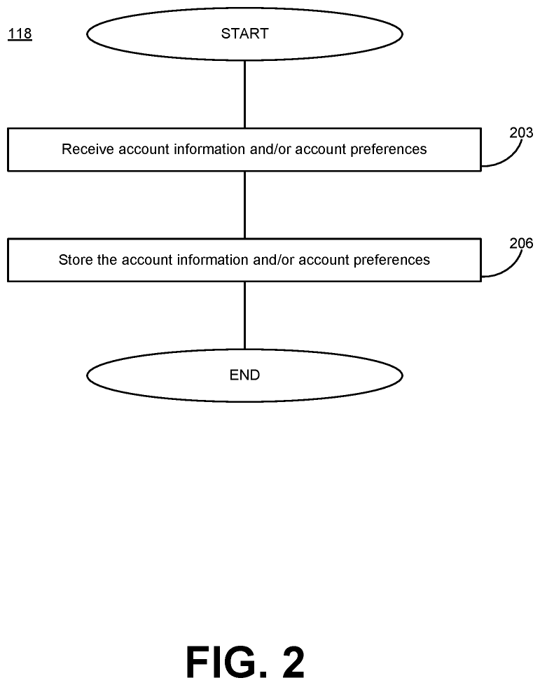

The merchant service 118 can be used to interact with merchants to collect merchant account preferences 142 and/or merchant account information 145. By receiving information about merchants, the computing environment 103 can maintain a comprehensive detailed list of merchants that includes their preferences on which payment rails they accept payment over and which payment accounts 133 are preferred for certain purposes (e.g., disbursements/payments from specific persons, businesses, or merchants; disbursements/payments for specific types of goods or services; disbursement/payments according to a specific time of the month/year, like different accounts for each quarter; disbursements/payments in response to paying late or delinquent payments, etc.). The merchant service 118 can be executed to perform various functions. For instance, the merchant service 118 can receive merchant account information 145 and/or merchant account preferences 142. Further, the merchant service 118 can store the merchant account information 145 and/or merchant account preferences 142. Further details on the detail service performing these functions are further described in the discussion of FIG. 2.

The exchange service 121 can be executed to receive a transfer of a set of funds, currency, or other property in exchange for a different set of funds, a different currency, or a different property. The exchange service 121 can be associated with one or more payment accounts 133. In various embodiments, the one or more payment accounts 133 can be used to exchange a first type of funds, currency, or other property to a second type of funds, currency, or other property. In at least some embodiments, a first exchange payment account 133 can be used to deposit a first form of funds, currency, or property. Additionally, a second exchange payment account 133 can hold a second form of funds, currency, or property, which can be withdrawn or removed.

The exchange service 121 can be executed to perform various functions. For example, the exchange service 121 can receive a first value of funds, currency, or other property on a first exchange payment account 133. The exchange service 121 can calculate a similar amount based on an exchange rate between the first type of the funds, currency, or other property and the second type of the funds, currency, or other property. For example, there can be an exchange rate between the United States Dollar (USD) and the British Pound (GBP) that indicates how many USD results in an equivalent GBP. The exchange service 121 can also include various fees to execute such an exchange. The exchange service 121 can then make the second type of funds, currency, or other property available to be withdrawn or removed on a second exchange payment account 133. In some embodiments, the exchange service 121 is executed by the computing environment 103. In some embodiments, the exchange service 121 can be executed by financial institutions 109.

The lender service 124 can be used to prepare or accept terms of a loan. The lender service 124 can be executed to perform various functions. For instance, the lender service 124 can receive a request for loan terms and send loan terms in response. Further, the lender service 124 can be used to execute a loan based on the loan terms. Accordingly, the lender service 124 can receive term requests for loan terms. In some embodiments, a merchant account 130 and/or a payment account 133 can be sent in the term request to identify the borrower. The lender service 124 can then determine various terms and conditions for the loan and provide a term response with such terms and conditions. The lender service 124 can then receive a term acceptance request that indicates that the terms and conditions are agreed upon. In some embodiments, the term acceptance request can also include one or more payment accounts 133 and additional instructions for how to disburse the loan. In some cases, the loan can be disbursed to the borrower. However, in some embodiments, the loan can be used to directly pay vendors or merchants at their preferred payment accounts 133. By doing this, the payment can be paid more expeditiously to the end recipient without having to make a stop at a client's payment account 133.

Also, various data is stored in a data store 127 that is accessible to the computing environment 103. The data store 127 can be representative of a plurality of data stores 127, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 127 is associated with the operation of the various applications or functional entities described below. This data can include merchant accounts 130, payment accounts 133A, a schedule of payments 136, and potentially other data.

The merchant accounts 130 can represent a business, merchant, or client of a system or software application. A merchant account 130 can also represent any information about a merchant or a merchant's representatives. The merchant account 130 can be used to store various types of information about the business, merchant, or client. For instance, the merchant accounts 130 can include merchant account identifiers 139 (alternatively called “merchant account ids 139”; singularly as “merchant account id 139”), merchant account preferences (singularly as “merchant account preference 142”), merchant account information 145, payment methods 148 (singularly as “payment method 148”), and potentially other data.

The merchant account identifiers 139 can represent any identifiers that could be used, alone or in combination with other identifiers, to uniquely identify a merchant account 130. For instance, the merchant account identifiers 130 can be a uniquely assigned number, string, or other value. The merchant account identifiers 130 could also be a name, or a partial name, of a company. The merchant account identifiers 130 could also include information that is typically part of the merchant account information 145, like a principle place of business, an address, a time zone, a key representative, or other information.

The merchant account preferences 142 can represent various choices that a merchant can make for how the merchant account 130 interacts with applications in the computing environment 103, with other merchant accounts 130, with payment accounts 133, payment methods 148, or with schedule of payments 136. In at least some embodiments, the merchant preferences can include references to one or more payment accounts 133 that can be used as a source funding account or a target disbursement account.

Further, the merchant account preferences can indicate that payment accounts 133 can be associated with paying or receiving funds, currency, or other property for specific purposes. For example, the merchant account preferences 142 can indicate that a first payment account 133 can be used (sending or receiving money) in relation to one or more merchants and a second payment account 133 can be used by any merchant not explicitly identified by the one or more merchants. In another example, the merchant account preferences 142 can indicate that a payment account 133 can be used for specific types of goods or services. For instance, the merchant account preferences 142 can indicate that one payment account 133 should be used for wholesale good payments, whereas a second payment account 133 could be used for other payments. In another example, the merchant account preferences 142 can indicate that certain payment accounts 133 be used for a certain time period. For instance, the merchant account preferences 142 can indicate that a first set of payment accounts are used for the first quarter of the year and a second set of payment accounts are used for the second quarter of the year. In another example, the merchant account preferences 142 can indicate that a payment account 133 can be used for paying fees, such as late fees or delinquent payments.

In at least some embodiments, the merchant account preferences 142 can also include information about payment methods 148. For instance, the merchant account preferences 142 can include account names, account routing information, account identifiers, account usernames, the ways in which a disbursement/payment can be initiated (e.g., ACH, RPC, blockchain protocols, internal bank transfer, etc.). The merchant account preferences 142 can also include a list of all acceptable payment rails that the payments methods 148 are capable of using. The merchant account preferences 142 can also include any payment rails any associated payment accounts 133 are capable of using.

The merchant account information 145 can represent information about the merchant. For example, the merchant account information 145 can include the merchant's name, the merchant's government identifiers (e.g., tax IDs, state business registration ID, etc.), number of employees, information about the merchant's representatives, or various other information. The merchant account information 145 could also include ways to get ahold of the merchant, such as a merchant's address, phone number, representative email address, fax information, or other ways to contact the merchant. The merchant account information 145 can also include keywords that can be used to search for the merchant account 130. In at least some embodiments, the merchant account information 145 can be associated with one or more a payment accounts 133. In at least some embodiments, specific merchant account information can be associated with one or more payment methods 148. Various other information can be stored with the merchant account information 145.

The payment methods 148 can represent the accounts by which a merchant can make a payment to some payment account 133. The payment method 148 could represent a payment account 133. In such embodiments, the payment method 148 can include various payment account information 154, such as routing numbers, account numbers, cryptographic keys to perform various blockchain functions, the payment rails that the payment account 133 can transact over, the type of currency, funding, or property within the payment account 133, or other information. In at least another embodiment, the payment method 148 could represent that a merchant account 130 is capable of making payments using a loan. In some embodiments, a disbursement service 115 or a merchant service 118 can interact with a lender service 124 to request terms and conditions for a loan to pay from. The terms and conditions of a loan can be stored in the payment methods 148 along with a date/time in which the terms and conditions were requested. After a period of time (as indicated by the loan, the payment account 133, or after a fixed timed), a payment method can expire and be unusable to pay from. The payment methods 148 can be saved or updated by the disbursement service 115, the merchant service 118, or by using a user interface rendered by a client application 160.

The payment accounts 133 can represent bank accounts, credit accounts, mortgage accounts, receivable accounts, negotiable instrument accounts, or any financial account. In some embodiments, a payment account 133 can be associated with a merchant account 130. In various embodiments, a payment account 133 can be used as a payment method 148 of a merchant account 130 to make payments. In various embodiments, a payment account 133 can be used as a recipient account to receive funding, currency, or property. In some embodiments, a first payment account 133 can be used to pay to or receive payments from a second payment account 133. In some embodiments, a payment account 133 can be an exchange payment account 133 that can be used by an exchange service 121. The payment accounts 133 can include payment account identifiers 151 (alternatively called “payment account ids 151”; singularly as “payment account id 151”), payment account information 154 (alternatively called “payment account info 154”), statements 157 (singularly as “statement 157”), and potentially other data.

The payment account identifiers 151 can represent any identifiers that could be used, alone or in combination with other identifiers, to uniquely identify a payment account 133. For instance, the payment account identifiers 151 can be a uniquely assigned number, string, or other value. The payment account identifiers 151 could also be a name, or a partial name, of a company associated with the account.

The payment account information 154 can represent various information about a payment account 133. For example, the payment account information 154 can include routing numbers, account numbers, cryptographic keys to perform various blockchain functions, the payment rails that the payment account 133 can transact over, the type of currency, funding, or property within the payment account 133, and various other information. The payment account information 154 can also include information about account balances, account credit limits, account terms or conditions, account interest rates, or other information.

The statements 157 can represent a historical tracing of each transaction, payment, disbursement, or transfer to or from the payment account 133. In some embodiments, a statement 157 can be an on-the-fly statement, such as a current listing of all the transactions currently pending as well as at least a portion of the historical transactions. In some embodiments, a statement 157 can be tied to a specific period of time (e.g., a month, a quarter, a year, etc.), such that only transactions during that period of time will appear. In at least some embodiments, the statements 157 can be used by the disbursement service 115 to determine a recommended payment method 148 for the payment account 133.

The schedule of payments 136 can represent a list of payments, disbursements, transactions, or transfers to occur on a specific date and/or time. The disbursement service 115 can schedule a payment, transaction, disbursement, or transfer (herein after “scheduled disbursement”) to be initiated on a specific date and/or time. The scheduled disbursement can be initiated to send funds, currency, or property from a payment account 133 identified from a payment method 148 associated with a merchant account 130. The scheduled disbursement can be initiated to send funds, currency, or property to a recipient payment account 133. In various embodiments, the schedule of payments 136 can indicate one or more payment methods 148 to effectuate a scheduled disbursement to one or more payment accounts 133.

In some embodiments, a currency exchange may need to occur to effectuate the scheduled disbursement. In such an embodiment, the scheduled disbursement can initiate a transfer from a payment account 133 to a first exchange payment account 133 a first type of funding, currency, or property. Then the exchange service can exchange the first type of funding, currency, or property to a second type of funding, currency, or property. Then, the scheduled disbursement can transfer the second type of funding, currency, or property from the second exchange payment account 133 to the target payment account 133.

In some embodiments, a payment method 148 may indicate that the source of the payment is a loan for a scheduled disbursement. In such an embodiment, the disbursement service 115 can send a request to the lender service 124 to accept the terms and conditions, the lender service 124A can make the funds available through a temporary payment account 133, and the disbursement service can initiate the transfer from the temporary payment account 133 to the target payment account 133.

The client device 106 is representative of a plurality of client devices that can be coupled to the network 112. The client device 106 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 106 can include one or more displays, such as liquid crystal displays (LCDs), gas plasma-based flat panel displays, organic light emitting diode (OLED) displays, electrophoretic ink (“E-ink”) displays, projectors, or other types of display devices. In some instances, the display can be a component of the client device 106 or can be connected to the client device 106 through a wired or wireless connection.

The client device 106 can be configured to execute various applications such as a client application 160 or other applications. The client application 160 can be executed in a client device 106 to access network content served up by the computing environment 103 or other servers, thereby rendering a user interface on the display. To this end, the client application 160 can include a browser, a dedicated application, or other executable, and the user interface can include a network page, an application screen, or other user mechanism for obtaining user input. The client device 106 can be configured to execute applications beyond the client application 160 such as email applications, social networking applications, word processors, spreadsheets, or other applications.

In some embodiments, the client device 106 can be used by a representative of a merchant associated with a merchant account 130 or by a representative of a business. To that end, the client application 160 can interact with the client application 160 to provide information that can be sent to the disbursement service 115 or the merchant service 118. For instance, the client application 160 can generate and send a request for the merchant service 118 to store merchant account information 145 and/or merchant account preferences 142, which the merchant service 118 can receive as further described in FIG. 2.

Additionally, the client application 160 can prompt the client to search for a merchant to make a payment to. The client application 160 can then generate and send a merchant search request, which the disbursement service 115 can receive at block 303 of FIG. 3A. The client application 160 can then receive the merchant search response that was sent by the disbursement service 115 at block 309 of FIG. 3A. The merchant search response can include one or more merchant accounts 130 that resulted from the search of merchants based on the client prompt. The client can choose at least one merchant account 130 from the one or more merchant accounts 130 and generate and send a chosen merchant information request indicated the at least one chosen merchant accounts 130, which the disbursement service 115 can receive at block 312 of FIG. 3A. The client application 160 can receive a chosen merchant response from the disbursement service 115, as described in block 324 of FIG. 3B. The client application 160 can display the payment methods 148, including any recommended payment methods 148, for the chosen merchant accounts. Additionally, the client application 160 can display a calendar or date/time picker affordance such that the client can choose when they would like the disbursement to be scheduled. The client application 160 can gather the client's selections of payment methods 148 and/or date/time to generate and send a disbursement schedule request, which the disbursement service 115 can receive at block 327 of FIG. 3B. Subsequently, the disbursement service 115 can send a confirmation that the disbursement has been initiated, which the client application 160 can display to the client.

The financial institutions 109 can include one or more computing devices that include a processor, a memory, and/or a network interface. For example, the computing devices can be configured to perform computations on behalf of other computing devices or applications. As another example, such computing devices can host and/or provide content to other computing devices in response to requests for content. Moreover, the financial institutions 109 can employ a plurality of computing devices that can be arranged in one or more server banks or computer banks or other arrangements. Such computing devices can be located in a single installation or can be distributed among many different geographical locations. For example, the financial institutions 109 can include a plurality of computing devices that together can include a hosted computing resource, a grid computing resource, or any other distributed computing arrangement. In some cases, the financial institutions 109 can correspond to an elastic computing resource where the allotted capacity of processing, network, storage, or other computing-related resources can vary over time.

Various applications or other functionality can be executed in the financial institutions 109. The components executed on the financial institutions 109 include an exchange service 121B (generically as “exchange service 121”), a lender service 124B (generically as “exchange service 121”), and other applications, services, processes, systems, engines, or functionality not discussed in detail herein. The exchange service 121B can be otherwise the same as the exchange service 121A run by the computing environment 103, except the exchange service 121B is run by a financial institution 109. The lender service 124B can be otherwise the same as the lender service 124A run by the computing environment 103, except the lender service 124B is run by a financial institution 109.

Additionally, the financial institutions 109 can include various data, including payment accounts 133B (generically as “payment accounts 133”) and potentially other data. The payment accounts 133B can be otherwise the same as the payment accounts 133A stored in the data store 127 of the computing environment 103, except the payment accounts 133B can be stored within the financial institutions 109. Although it is not depicted here, the payment accounts 133B can also include payment account identifiers 151, payment account information 154, and statements 157, as described with payment accounts 133A.

Referring next to FIG. 2, shown is a flowchart that provides one example of the operation of a portion of the merchant service 118. The flowchart of FIG. 2 provides merely an example of the many different types of functional arrangements that can be employed to implement the operation of the depicted portion of the merchant service 118. As an alternative, the flowchart of FIG. 2 can be viewed as depicting an example of elements of a method implemented within the network environment 100.

Beginning with block 203, the merchant service 118 can receive merchant account information 145 and/or merchant account preferences 142. In some embodiments, the merchant account information and/or the merchant account preferences 142 can be sent by a client device 106 of a merchant representative and received by the merchant service 118. The merchant account information 145 can represent information about the merchant. For example, the merchant account information 145 can include the merchant's name, the merchant's government identifiers (e.g., tax IDs, state business registration ID, etc.), number of employees, information about the merchant's representatives, or various other information. The merchant account information 145 could also include ways to get ahold of the merchant, such as a merchant's address, phone number, representative email address, fax information, or other ways to contact the merchant. The merchant account information 145 can also include keywords that can be used to search for the merchant account 130. In at least some embodiments, the merchant account information 145 can be associated with one or more a payment accounts 133. In at least some embodiments, specific merchant account information can be associated with one or more payment methods 148. Various other information can be stored with the merchant account information 145.

The merchant account preferences 142 can represent various choices that a merchant can make for how the merchant account 130 interacts with applications in the computing environment 103, with other merchant accounts 130, with payment accounts 133, payment methods 148, or with schedule of payments 136. Further, the merchant account preferences 142 can indicate that payment accounts 133 can be associated with paying or receiving funds, currency, or other property for specific purposes. In at least some embodiments, the merchant account preferences 142 can also include information about payment methods 148. Various other information can be stored with the merchant account preferences 142.

Continuing to block 206, the merchant service 118 can store the merchant account information 145 and/or the merchant account preferences 142. The merchant service 118 can store the merchant account information 145 and/or the merchant account preferences 142 in a data store 127 on the computing environment 103. Once block 206 has completed, the flowchart of FIG. 2 can come to an end.

Referring next to FIGS. 3A and 3B, shown is a flowchart over two drawings that provide one example of the operation of a portion of the disbursement service 115. The flowchart of FIGS. 3A and 3B provide merely an example of the many different types of functional arrangements that can be employed to implement the operation of the depicted portion of the disbursement service. As an alternative, the flowchart of FIGS. 3A and 3B can be viewed as depicting an example of elements of a method implemented within the network environment 100.

Beginning with block 303 of FIG. 3A, the disbursement service 115 can receive a merchant search request from a client device 106. The client application 160 can prompt a client to search for a merchant to whom the client wishes to make a payment or disbursement. The client application 160 can receive a text response from the prompt to the client. Accordingly, the client application 160 can generate a merchant search request that includes the text response from the prompt to the client to search for a merchant to whom the client wishes to make a payment or disbursement. The text response from the prompt to the client can be a search term that could match a value stored in at least one of the merchant account identifiers 139 or the merchant account information 145. The client application 160 can send that merchant search request, and the disbursement service 115 can receive the merchant service request along with the text response from the prompt to the client.

Next, at block 306, the disbursement service 115 can identify one or more merchant accounts 130 based on the merchant search request. In at least some embodiments, the disbursement service 115 can identify one or more merchant accounts 130 based at least in part on a match or a partial match of the search term received at block 303 to merchant account information 145. To do so, the disbursement service 115 can compare the search term to at least the merchant account information 145 or the merchant account identifiers 139 to identify the one or more merchant accounts 130 that provide a match or a partial match to the search term. In some embodiments, the resulting one or more merchant accounts 130 can be sorted based on how much of a match of the search term exists within the merchant account information 145 or the merchant account identifiers 139.

Continuing to block 309, the disbursement service 115 can send a merchant search response to the client application 160 on the client device 106. In at least some embodiments, the merchant search response can include one or more merchant accounts 130. In some embodiments, the merchant search response can include one or more merchant account identifiers 139. In such embodiments, each merchant account identifier 139 of the one or more merchant account identifiers 139 can uniquely identify its respective merchant account 130. The merchant search response can then be sent to the client application 160 of the client device 106.

Next, at block 312, the disbursement service 115 can receive a chosen merchant information request. In various embodiments, the chosen merchant information request can include one or more chosen merchant accounts 130 or one or more chosen merchant account identifiers 139 that correspond to merchant account 130. In some embodiments, the chosen merchant information request can also include a proposed disbursement due date entered by the client that represents when the client wishes to have executed the disbursement by that date. The chosen merchant information request can also include various other information, such as the purpose for the disbursement, an amount to be transferred, or various other information.

Continuing to block 315, the disbursement service 115 can identify one or more disbursement methods accepted by the chosen merchant account 130. The disbursement methods for the chosen merchant account 130 can represent payment accounts 133 or other payment methods 148 for which funds, currency, or property can be sent. In various embodiments, this means that the disbursement service 115 can identify payment methods 148 associated to the chosen merchant account 130. In various other embodiments, the disbursement service 115 can review the merchant account preferences 142 to determine one or more disbursement methods accepted by the chosen merchant. By identifying the one or more disbursement methods, the client can ultimately choose the payment method or payment account 133 over which they want to pay the merchant account 130.

In various embodiments, at least one of the disbursement methods can represent obtaining a loan to complete the disbursement. In at least another embodiment, the payment method 148 could represent that a merchant account 130 is capable of making payments using a loan. In some embodiments, a disbursement service 115 or a merchant service 118 can interact with a lender service 124 to request terms and conditions for a loan to pay from. The terms and conditions of a loan can be stored in the payment methods 148 along with a date/time in which the terms and conditions were requested.

Next, at block 318, the disbursement service 115 can identify scheduled disbursements made by other clients to the chosen merchant account 130. In some embodiments, the disbursement service 115 can gather information to determine whether they want to recommend or incentivize or disincentivize a client to choose a specific payment rail. In at least some embodiments, the disbursement service 115 can review a schedule of payments 136 to see if the target merchant account 130 has any upcoming scheduled disbursements and, if so, which payment method 148 is being used to effectuate the disbursement. For example, a first client might want to schedule a disbursement to pay Acme Organization on December 20^{th} The disbursement service 115 can identify that a second client has already scheduled a disbursement to pay Acme Organization on December 20^{th}, and they are paying Acme Organization via a blockchain payment account 133. In such a situation, by identifying scheduled disbursements made by other clients to the chosen merchant account 130, the disbursement service 115 can determine an adjustment to the cost of using such a payment method 148 or payment rail that can incentivize or disincentivize a client to make additional payments to that payment method 148 or payment rail for the merchant account 130. In at least one embodiment, the disbursement service 115 can incentivize using the same payment method 148 or payment rail as a previously scheduled payment because the computing environment 103 might be able to bundle the payments together within a single account and then initiated disbursements from a single source payment account 133 to the target payment account(s) 133.

Continuing to block 321 on FIG. 3B, the disbursement service 115 can determine a recommended disbursement method. In at least some embodiments, the disbursement service 115 can determine the recommended disbursement method of the one or more disbursement methods based at least in part on the disbursement due date received at block 312. For example, if a client identifies that a disbursement be delivered within a few hours, then certain types of disbursement methods would be difficult to implement due to their time requirements. For instance, Automated Clearing House (ACH) payments often take 2-4 days to clear from a first payment account 133 to a second payment account 133. However, Real-Time

Payments (RTP) can be processed/initiated immediately. Accordingly, a disbursement service 115 can determine to recommend an RPC payment method 148 over an ACH payment method 148 for the recommended disbursement method.

In at least some embodiments, the disbursement service 115 can also determine the recommended disbursement method based at least in part on the prices assigned to the one or more disbursement methods. There may be costs associated with performing transactions over certain payment rails. The costs could be fixed cost or variable costs based on the specific method. However, in some situations there could be a need to keep costs to a minimum for certain clients or in certain circumstances. Accordingly, the cost of disbursing the funds, currency, or property over the payment method 148 can also be a factor in determining a recommended disbursement method. As previously discussed, the disbursement service 115, at block 318, can determine an adjustment to the cost of using such a payment method 148 or payment rail that can incentivize or disincentivize a client to make additional payments to that payment method 148 or payment rail for the merchant account 130. Such adjustments can impact the recommendation of the disbursement method.

In some embodiments, the disbursement service 115 can also determine a recommended disbursement method based at least in part on any payment rails that both the source merchant account 130 and the target merchant account 130 can transact on without an intermediary payment account 133 or an exchange payment account 133. As an example, a first merchant account 130 may only be able to transact over ACH and a second merchant account 130 may be able to transact over both RTP and ACH. Because both the first merchant account 130 and the second merchant account 130 have payment methods 148 that can transact over ACH, the disbursement service 115 can recommend the payment method 148 to transact over ACH. The system can also recommend the disbursement method over various other ways, as understood by other portions of this disclosure.

Next, at block 324, the disbursement service 115 can send a chosen merchant information response. The merchant information response can include the one or more disbursement methods identified at block 315, prices or costs to use such disbursement methods, and one or more recommended disbursement methods with a corresponding recommended price, as described in block 321. In at least some embodiments the recommended price can be an amended price from the original price for using that disbursement method, as described in block 318. In at least some embodiments, such an amended price can be a discount, as described in block 318.

Next, at block 327, the disbursement service 115 can receive a disbursement schedule request. In various embodiments, the disbursement schedule request can include a chosen disbursement method and a disbursement amount. The disbursement schedule request can also include various other information, such as a message to send with the disbursement or various other information.

Continuing to block 330, the disbursement service 115 can initiate a disbursement to the chosen merchant. In various embodiments, the disbursement service 115 can initiate the disbursement for the disbursement amount over a payment rail that corresponds to the chosen disbursement method. For example, if the disbursement method chosen was for an ACH disbursement, then the disbursement service 115 can initiate a disbursement over an ACH payment rail.

In at least some embodiments, the chosen disbursement method is for a loan. The disbursement service 115 can send a request to the lender service 124 to accept the terms and conditions of the loan. Then, the disbursement service 115 can initiate a transfer from the lender's payment account 133 to a target payment account 133. In at least one embodiment, the loan can be disbursed to the borrower (the client accepting the terms and conditions of the loan). However, in some embodiments, the loan can be used to directly pay vendors or merchants at their preferred payment accounts 133. By doing this, the payment can be more expeditiously paid to the end recipient without having to make a stop at a client's payment account 133.

In some embodiments, a source merchant account 130 (from which the funding, currency, or property is sourced) has access to different payment rails than a target merchant account 130 (to which the funding, currency, or property is to be disbursed). In such a situation, the disbursement service 115 can prepare an intermediary payment account 133 that can communicate with both the payment account 133 of the source merchant account 130 and the payment account 133 of the target merchant account 130. The disbursement service 115 can initiate a transfer from the payment account 133 of the source merchant account 130 to the intermediary payment account 133, then initiate a transfer from the intermediary payment account 133 to the payment account 133 associated with the target merchant account 130. In at least some embodiments the first transfer from the payment account 133 of the source merchant account 130 to the intermediary payment account 133 can be an interbank transfer.

In at least another embodiment, a source merchant account 130 (from which the funding, currency, or property is sourced) is in a different form than a target merchant account 130 (to which the funding, currency, or property is to be disbursed) such that an exchange service 121 can be utilized to place complete the disbursement. The disbursement service 115 can initiate a disbursement to the exchange service 121, which can receive a first value of funds, currency, or other property on a first exchange payment account 133. The exchange service 121 can calculate a similar amount based on an exchange rate between the first type of the funds, currency, or other property and the second type of the funds, currency, or other property. For example, there can be an exchange rate between the United States Dollar (USD) and the British Pound (GBP) that indicates how many USD results in an equivalent GBP. The exchange service 121 can also include various fees to execute such an exchange. The exchange service 121 can then make the second type of funds, currency, or other property available to be withdrawn or removed on a second exchange payment account 133. The disbursement service 115 can then initiate a disbursement from the second exchange payment account 133 to the payment account 133 of the target merchant account 130. Once block 330 has completed, the flowchart of FIGS. 3A and 3B can come to an end.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random-access portion of the memory and run by the processor, source code that can be expressed in proper format such as object code that is capable of being loaded into a random-access portion of the memory and executed by the processor, or source code that can be interpreted by another executable program to generate instructions in a random-access portion of the memory to be executed by the processor. An executable program can be stored in any portion or component of the memory, including random-access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer- readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 103.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine-readable instructions stored in the memory that, when executed by the processor, cause the computing device to at least:
send, to a client device, a first response, the first response comprising one or more identifiers, each identifier of the one or more identifiers uniquely identifying a respective account;
receive, from the client device, a first request, the first request comprising a chosen identifier from the one or more identifiers, the chosen identifier corresponding to a chosen account;
identify one or more disbursement methods accepted by the chosen account;
send, to the client device, a second response, the second response comprising the one or more disbursement methods;
receive, from the client device, a second request, the second request comprising a chosen disbursement method from the one or more disbursement methods and a disbursement amount; and
initiate a disbursement for the disbursement amount over a payment rail, the payment rail corresponding to the chosen disbursement method.

2. The system of claim 1, wherein the machine-readable instructions further cause the computing device to at least:
receive, from a merchant device, account information corresponding to the account, the account information comprising the one or more disbursement methods; and
store the account information in association with an identifier that corresponds to the account.

3. The system of claim 1, wherein the second response further comprises corresponding prices assigned to the one or more disbursement methods.

4. The system of claim 3, wherein the second response further comprises a recommended disbursement method of the one or more disbursement methods and a recommended price of the corresponding prices.

5. The system of claim 4, wherein the first request further comprises a disbursement due date and the machine-readable instructions further cause the computing device to at least determine the recommended disbursement method of the one or more disbursement methods based at least in part on the disbursement due date and the corresponding prices assigned to the one or more disbursement methods.

6. The system of claim 1, wherein the second request indicates that the disbursement should be funded by a loan, and the machine-readable instructions that initiate the disbursement further cause the computing device to at least send, to a lender service, a third request comprising directions to disburse the disbursement amount over the payment rail from the lender to the chosen account.

7. The system of claim 1, wherein the machine-readable instructions that send the first response are executed in response to identifying the one or more identifiers and the machine-readable instructions further cause the computing device to at least:
receive, from the client device, a third request, the third request comprising a search term; and
identify the one or more identifiers based at least in part on a partial match of the search term to account information associated with the one or more identifiers.

8. A method, comprising:
receiving, by a computing device and from a client device, a first request to prepare a disbursement to a target account;
identifying, by the computing device, target account preferences, the target account preferences comprising disbursement methods accepted by the target account;
sending, by the computing device and to the client device, the disbursement methods accepted by the target account;
receiving, by the computing device and from the client device, a chosen disbursement method and a disbursement amount; and
initiating, by the computing device, a disbursement for the target account to receive the disbursement amount, the disbursement using at least the chosen disbursement method.

9. The method of claim 8, wherein initiating the disbursement comprises:
initiating, by the computing device, a first transfer from a client account to a disbursement account, the client account is unable to perform the disbursement over the chosen disbursement method, and the disbursement account is able to perform the disbursement over the chosen disbursement method; and
perform, by the computing device, the disbursement from the disbursement account to the target account over the chosen disbursement method.

10. The method of claim 9, wherein the first transfer from the client account to the disbursement account is an interbank transfer.

11. The method of claim 9, wherein the client account is able to transfer the disbursement amount over at least a first disbursement method and a second disbursement method, the disbursement account is able to receive the disbursement amount over the first disbursement method, the second disbursement method, and the chosen disbursement method, and the method further comprises selecting, by the computing device and based at least on an expected transfer delivery date, a preferred disbursement method from a set of the first disbursement method and the second disbursement method.

12. The method of claim 9, wherein initiating the first transfer further comprises:
transferring, by the computing device, an initial amount of a first currency from the client account to an exchange account, the initial amount of the first currency being equivalent to the disbursement amount of a second currency; and
transferring, by the computing device, the disbursement amount of the second currency to the disbursement account.

13. The method of claim 8, further comprising sending, by the computing device to the client device, disbursement prices, each disbursement price of the disbursement prices corresponds to at least one disbursement method of the disbursement methods.

14. The method of claim 13, wherein the client device is a second client device, the disbursement is a second disbursement, and the method further comprising:
identifying, by the computing device, that a first client device has scheduled a first disbursement to the target account over a first disbursement method; and
sending, by the computing device and to the second client device, an amended price corresponding to the first disbursement method.

15. The method of claim 14, wherein the amended price is a discount from the corresponding disbursement price.

16. A non-transitory, computer-readable medium, comprising machine-readable instructions that, when executed by a processor of a computing device, cause the computing device to at least:
send, to a client device, a first response, the first response comprising one or more identifiers, each identifier of the one or more identifiers uniquely identifying a respective account;
receive, from the client device, a first request, the first request comprising a chosen identifier from the one or more identifiers, the chosen identifier corresponding to a chosen account;
identify one or more disbursement methods accepted by the chosen account;
send, to the client device, a second response, the second response comprising the one or more disbursement methods;
receive, from the client device, a second request, the second request comprising a chosen disbursement method from the one or more disbursement methods and a disbursement amount; and
initiate a disbursement for the disbursement amount over a payment rail, the payment rail corresponding to the chosen disbursement method.

17. The non-transitory, computer-readable medium of claim 16, wherein the machine-readable instructions further cause the computing device to at least:
receive, from a merchant device, account information corresponding to the account, the account information comprising the one or more disbursement methods; and
store the account information in association with an identifier that corresponds to the account.

18. The non-transitory, computer-readable medium of claim 16, wherein the second response indicates that the disbursement should be funded by a loan, and the machine-readable instructions that initiate the disbursement further cause the computing device to at least send, to a lender service, a third request comprising directions to disburse the disbursement amount over the payment rail from the lender to the chosen account.

19. The non-transitory, computer-readable medium of claim 16, wherein the machine-readable instructions that send the first response are executed in response to identifying the one or more identifiers and the machine-readable instructions further cause the computing device to at least:
receive, from the client device, a third request, the third request comprising a search term; and
identify the one or more identifiers based at least in part on a partial match of the search term to account information associated with the one or more identifiers.

20. The non-transitory, computer-readable medium of claim 16, wherein the machine-readable instructions that initiate the disbursement further cause the computing device to at least:
initiate a first transfer from a client account to a disbursement account, the client account being unable to perform the disbursement over the chosen disbursement method, and the disbursement account being able to perform the disbursement over the chosen disbursement method; and
perform the disbursement from the disbursement account to the chosen account using the chosen disbursement method.
